(19) United States
(12) Patent Application Publication
(10) Pub. No.: US 2003/0094338 A1
(43) Pub. Date: May 22, 2003

(54) Drum brake backing plate

(76) Inventor: Manuel Barbosa, Novi, MI (US)

Correspondence Address: CLARK & BRODY, Suite 600, 1750 K Street, NW, Washington, DC, 20006, US

(21) Appl. No.: 09/988,193

(22) Filed: Nov. 19, 2001

(51) Int. Cl. F16D 69/00

(52) U.S. Cl. 188/218 A

(57) ABSTRACT

A backing plate for a drum brake system comprises an abutment plate made of strong material and a shielding plate that is lighter and is made of noise and vibration dampening material. The abutment plate attaches to the vehicle and is configured to engage brake shoes to resist braking forces. The shielding plate is preferably made of relatively this damped steel to reduce the speaker effect of the backing plate and reduce overall NVH.

### FIELD OF THE INVENTION

This invention relates to the art of drum brakes. In particular, the invention relates to improvements in drum brakes by the use of a backing plate structure that reduces noise and weight.

### BACKGROUND ART

The structure of drum brakes is well known to include a structure that engages the vehicle axle and supports brake shoes. In a common arrangement, the drum brake structure includes a backing plate that bolts to the vehicle axle and supports the drum brake shoes. In this arrangement, the backing plate has substantial strength in order to resist the braking forces applied to the backing plate by the brake shoes. Because this backing plate must have substantial strength, it is often made of relatively thick steel and is, therefore, relatively heavy. For example, a typical backing plate is made of steel having a thickness of about 2.8 mm with a steel abutment about 4 mm thick secured to the backing plate. Such a backing plate weighs about 2.4 pounds.

Reduction of weight in automotive components is an important objective to achieve cost reduction and fuel efficiency, and components such as a backing plate have often been considered for improvement.

In addition, the manufacture of the typical brake system requires expensive tooling because of the large tonnage and numerous forming stations required to manufacture the typical backing plate.

Another characteristic of known backing plates is that vibrations of the brake shoes during application of braking forces induce vibrations in the backing plate. Because the backing plate is relatively large, it acts as a speaker amplifying the vibrations and generating substantial acoustical noise. Reduction of this noise is another important objective in the design of brake systems.

Prior systems have attempted to reduce the sound generated by the backing plate in a variety of ways. In one technique, one or more sound masses are attached to the backing plate at locations designed to disrupt harmonic vibrations. This technique, however, is expensive to implement and does not result in effective reductions of sound generation.

### SUMMARY OF THE INVENTION

In accordance with the invention, a new design backing plate structure is provided that is lighter and dampens sounds to result in a lighter, less expensive, and quieter drum brake system. The new system employs a two-part structure wherein the first part is an abutment plate that is bolted to the axle and designed to resist the braking forces applied by the brake shoes. This abutment plate is strong and can be made of relatively thick material, but it represents only a small part of the overall structural area of the brake structure. The abutment plate is preferably large enough to attach to the vehicle axle and to provide one or more anchors for resisting movement of the brake shoes during braking. The abutment plate is preferably made of steel and 3 mm-6 mm thick. Preferably the thickness of the abutment plate is about 4 mm.

The new backing plate structure also includes a shielding plate that is preferably separate from the abutment plate. Because the abutment plate is strong enough to accept the braking forces, the shielding plate itself can made thinner and, therefore, lighter than previous backing plates. In essence the shielding plate need only perform the function of shielding the brake components from entry of dirt and dust. In accordance with an important aspect of the invention, however, the shielding plate is also made of a sound and noise dampening material, preferably damped steel, to reduce the speaker effect of the backing plate and, therefore, reduce the sound emitted by the brake system. Thus not only does the new backing plate reduce weight, for example by more than 0.5 pounds, but it also effectively reduces the noise, vibration and harshness (NVH). Additionally, the backing plate of the invention is easier to manufacture, thus further reducing costs.

The shielding plate is preferably made of damped steel, which comprises two layers of steel with a sound-dampening layer between the steel layers. In the preferred construction, the layers of steel are of approximately equal thickness to provide the most efficient sound dampening effect. Of course, other constructions having improved sound attenuating characteristics may be found useful, and it will be understood that a variety of other constructions are possible because the abutment plate eliminates the requirement that the backing plate resist the braking forces. In the preferred embodiment, the damped steel has an overall thickness of 0.8 mm-1.8 mm and preferably about 1.2 mm.

It is an object of the present invention to reduce the weight of drum brake assemblies.

It is a further object of the present invention to reduce NVH contributions from drum brake assemblies.

It is a still further object of the invention to provide an improved drum brake assembly of reduced cost.

### BRIEF DESCRIPTION OF THE DRAWINGS

FIG. 1 is a front view of a backing plate structure in accordance with the invention.

FIG. 2 is a vertical cross section of the structure of FIG. 1.

FIG. 3 is an enlarged, partial cross section of the backing plate of FIG. 1.

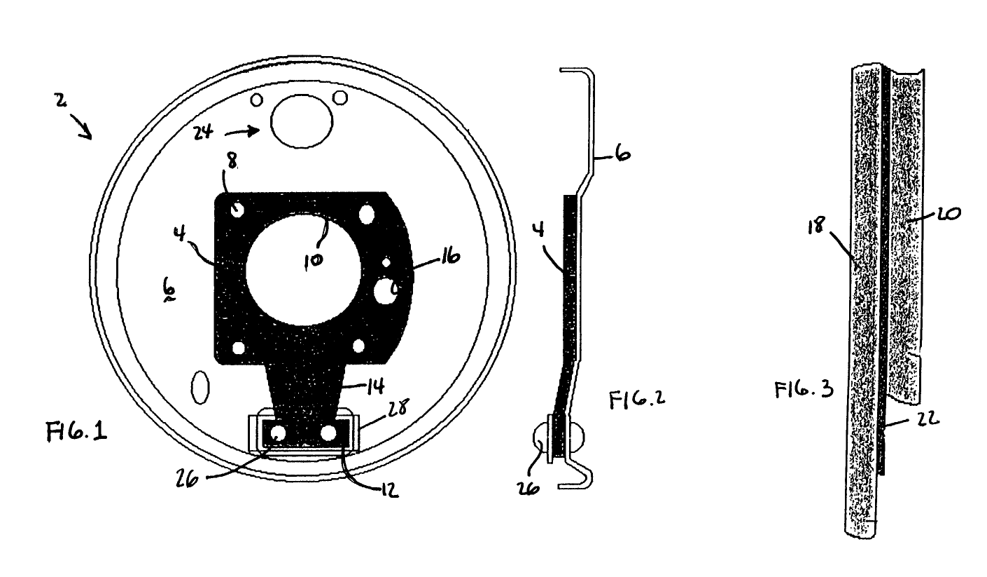

### DETAILED DESCRIPTION OF THE PREFERRED EMBODIMENT

With reference to the drawing figures, a drum brake backing plate system 2 in accordance with the invention includes an abutment plate 4 and a shielding plate 6.

The abutment plate is made of a material that is strong enough to resist the braking forces applied to it by the brake shoes (not shown). For example, the abutment plate may be steel of approximately 4 mm thickness or equivalent material. The abutment plate includes an upper portion that may be approximately square and measuring about 100 mm on each side. The upper portion includes holes 8 for securing the abutment plate to the axle housing (not shown) of a vehicle. A large opening 10 is provided for the axle (not shown). A lower portion of the abutment plate includes an abutment 12 configured to engage the ends of the brake shoes and accept braking forces. The lower portion forming the abutment 12 is connected to the upper portion by a mid-portion 14. It will be appreciated that geometric shapes other than those shown may be employed.

Further, the abutment plate may include a portion having a mounting hole (16) for receiving an antilock braking sensor (not shown). This allows the ABS to be mounted to rigid structure.

As noted above, the shielding plate 6 is preferably made of material that is much lighter than the material forming the abutment plate and is further a material having sound, or vibration, dampening characteristics. Such a material may be that which is known as damped steel and a preferred form of that is shown in more detail in FIG. 3. As illustrated there, the damped steel comprises a first layer 18 of steel, a second layer 20 of steel, and an intermediate layer 22 of vibration dampening material, such as a viscoelastic polymer.

The shielding plate 6 may also support those elements of the brake system that are compatible with the characteristics of the shielding plate. For example, the shielding plate may support a hydraulic cylinder (not shown) at mounting holes as generally designated at 24.

Damped steel by itself is a known structure and is commercially available. Further, the vibration dampening characteristics of damped steel has been investigated. Generally, it has been found that damped steel is more effective if the steel layers are of approximately equal thickness. Use of damped steel alone for the entire backing plate would not be practical because the requirement for strength would dictate a thickness for the one steel layer that would result in an overall thickness that is too large for optimum dampening performance to be achieved.

The lower part of the backing plate is attached to the lower part of the abutment plate in the embodiment shown by rivets 26 that extend through the backing plate, the abutment plate and washer plate 28. The bolts passing through holes 8 secure the upper part of the abutment plate and the central part of the shielding plate to each other. Clearly, other configurations maybe required for other brake designs.

It will be appreciated that a unique drum brake assembly backing plate of reduced weight and having improved NVH has been described. Modifications within the scope of the appended claims will be apparent to those of skill in the art.

I claim:

1. A backing plate comprising:
abutment plate means for resisting braking forces, and shielding plate means for shielding brake components from dust and dirt and reducing noise and vibrations.

2. A backing plate according to claim 1 wherein said shielding means is made of damped steel.

3. A backing plate according to claim 2 wherein said damped steel comprises outer and inner layers of steel and an inner layer of vibration dampening material, said layers of steel being of approximately equal thickness.

4. A backing plate comprising an abutment plate having a first part configured to be attached to an axle of a vehicle and a second part configured to resist braking forces and a shielding plate configured to shield brake components and made of a material that dampens noise and vibrations.

5. A backing plate according to claim 4 wherein said material is damped steel.

6. A backing plate according to claim 5 wherein said damped steel comprises first and second layers of steel of approximately equal thickness.

7. A backing plate according to claim 4 wherein said abutment plate is made of steel.

8. A backing plate according to claim 7 wherein said material is damped steel.

9. A shielding plate comprising a sheet of damped steel configured to be attached to a vehicle and to protect brake components from dust and dirt.

10. A shielding plate according to claim 9 wherein said brake components are components of a drum brake.

11. A shielding plate according to claim 10 in further combination with an abutment plate configured to engage brake shoes and to resist braking forces applied by said brake shoes.

12. A shielding plate according to claim 11 wherein said damped steel comprises first and second layers of steel on opposite sides of a dampening material, said first and second layers having approximately equal thickness.
